(19) United States
(12) Patent Application Publication
(10) Pub. No.: US 2026/0135312 A1
(43) Pub. Date: May 14, 2026

(54) HIGH-SPEED CONNECTOR WITH GROUNDING STRUCTURE

(71) Applicant: ZHEJIANG ZHAOLONG INTERCONNECT TECHNOLOGY CO., LTD., Zhejiang (CN)

(72) Inventors: Chun-Hua CHEN, Zhejiang (CN); Chun-Hsu CHEN, Zhejiang (CN); Li-Feng WANG, Zhejiang (CN); Jian JI, Zhejiang (CN)

(73) Assignee: ZHEJIANG ZHAOLONG INTERCONNECT TECHNOLOGY CO., LTD., Zhejiang (CN)

(21) Appl. No.: 19/335,478

(22) Filed: Sep. 22, 2025

(30) Foreign Application Priority Data
Nov. 12, 2024 (CN) 202422757318.6

(51) Int. Cl. H01R 12/77

(52) U.S. Cl. CPC H01R 12/777

(57) ABSTRACT

A high-speed connector includes a flat cable and a grounding structure. The flat cable includes grounding wires, signal wires, and a bundle clamping portion. The grounding structure includes a body. Two wings of the body are formed with two symmetrical clamping portions. The two clamping portions clamp onto two wings of the bundle clamping portion. Two contact legs extend from a position on one side of the two wings of the body. After the body is assembled on the bundle clamping portion, the two grounding wires on the two wings of the flat cable are electrically connected to the body, so the two contact legs are positioned in gaps left after the two grounding wires are electrically connected to the body. The two contact legs, the grounding wires, and the signal wires are electrically connected to a plurality of pins of a plug.

### CROSS-REFERENCE TO RELATED APPLICATION

This application claims benefit of priority to Chinese Patent Application No. 202422757318.6 filed Nov. 12, 2024, the entire contents of which are incorporated herein by reference.

### BACKGROUND OF THE DISCLOSURE

### Technical Field

The present disclosure relates to a connector, and more particularly to a high-speed connector with a grounding structure.

### Description of Related Art

It is known that high-speed connectors are applied in various applications, such as industry, automobiles, communications, medical apparatuses, and automated robots. A high-speed connector is a type of connector which is used for the high-speed data transmission, and is usually used in the fields such as computers, communication equipment, industrial automation, and medical equipment. The main function of the high-speed connector is to connect apparatuses and to transmit data, with a transmission rate faster than that of the ordinary connector. The high-speed connector is capable of ensuring the stability and the reliability of the data transmission.

A related art high-speed connector includes a plug and a flat cable. The flat cable includes a plurality of grounding wires and a plurality of signal wires. The grounding wires and the signal wires are electrically connected to a plurality of pins of the plug, respectively. When the high-speed connector is connected to apparatuses, data may be rapidly transmitted between the apparatuses.

Because all of the grounding wires of the flat cable are electrically connected to the pins of the plug, the signal is prone to attenuation or interference during the signal transmission, resulting in poor and unstable signal transmission performance.

Therefore, how to achieve good and stable signal transmission performance without interference is the problem to be solved by the present disclosure.

### SUMMARY OF THE INVENTION

Therefore, the main object of the present disclosure is to solve the problems mentioned above. The present disclosure redesigns the high-speed connector by additionally providing a grounding structure on the high-speed connector, so that a portion or all of the grounding wires of the flat cable are electrically connected to the grounding structure, thereby achieving good and more stable signal transmission performance, with the signal being less prone to attenuation or interference.

To achieve the object mentioned above, the present disclosure provides a high-speed connector electrically connected to a plug of a connector. The high-speed connector includes: a flat cable and a grounding structure. The flat cable includes a plurality of grounding wires and a plurality of signal wires arranged in sequence, and includes a bundle clamping portion on the grounding wires and the signal wires. The grounding wires and the signal wires extend outwardly from one side of the bundle clamping portion to be exposed. The grounding structure is assembled on the bundle clamping portion and includes a body. Two wings of the body are bent to form two clamping portions which are symmetrical to each other. The two clamping portions clamp onto two wings of the bundle clamping portion. Two contact legs extend from a position on one side of the two wings of the body. Moreover, after the body is assembled on the bundle clamping portion, the two grounding wires on two wings of the flat cable are electrically connected to the body, so that the two contact legs are positioned in gaps left after the two grounding wires are electrically connected to the body. Then, the two contact legs, the grounding wires, and the signal wires are electrically connected to a plurality of pins of the plug.

In one embodiment of the present disclosure, an arrangement of the grounding wires and the signal wires of the flat cable is sequentially from right to left as follows: a first grounding wire, a second signal wire, a third signal wire, a fourth grounding wire, a fifth signal wire, a sixth signal wire, and so on, up to a last grounding wire. Moreover, the two grounding wires on the two wings of the flat cable are bent upward or downward to be electrically connected to the body.

In one embodiment of the present disclosure, the body is in a form of a long strip or a plate.

In one embodiment of the present disclosure, after the body of the grounding structure is assembled on the bundle clamping portion of the flat cable, the two contact legs are arranged at a same height and adjacent to the signal wires.

In one embodiment of the present disclosure, the body is provided with at least one through hole. A metal layer is coated on a surface of the bundle clamping portion. After the body is assembled on the bundle clamping portion, a solder is soldered onto the through hole, so that the body is fixedly connected to the metal layer.

To achieve the object mentioned above, the present disclosure further provides a high-speed connector electrically connected to a plug of a connector. The high-speed connector includes: a flat cable and a grounding structure. The flat cable includes a plurality of grounding wires and a plurality of signal wires arranged in sequence, and includes a bundle clamping portion on the grounding wires and the signal wires. The grounding wires and the signal wires extend outwardly from one side of the bundle clamping portion to be exposed. The grounding structure is assembled on the bundle clamping portion, and includes a body. An extension portion extends from one side of the body. A plurality of contact legs extends from one side of the extension portion. Moreover, after the body is assembled on the bundle clamping portion, the grounding wires of the flat cable are electrically connected to the body. The contact legs are positioned in gaps left after the grounding wires are electrically connected to the body. Then, the two contact legs and the signal wires are electrically connected to a plurality of pins of the plug.

In one embodiment of the present disclosure, an arrangement of the grounding wires and the signal wires of the flat cable is sequentially from right to left as follows: a first grounding wire, a second signal wire, a third signal wire, a fourth grounding wire, a fifth signal wire, a sixth signal wire, and so on, up to a last grounding wire. Moreover, the grounding wires of the flat cable are bent upward or downward to be electrically connected to the body.

In one embodiment of the present disclosure, the body is frame-shaped.

In one embodiment of the present disclosure, after the body of the grounding structure is assembled on the bundle clamping portion of the flat cable, the contact legs are arranged at a same height and adjacent to the signal wires.

In one embodiment of the present disclosure, the body is provided with at least one through hole. A metal layer is coated on a surface of the bundle clamping portion. After the body is assembled on the bundle clamping portion, a solder is soldered onto the through hole, so that the body is fixedly connected to the metal layer.

### BRIEF DESCRIPTION OF THE DRAWINGS

FIG. 1 shows an exploded appearance perspective view schematically illustrating the connection between the grounding structure and the flat cable according to the first embodiment of the present disclosure.

FIG. 2 shows a view schematically illustrating the appearance and the assembled connection between the grounding structure and the flat cable of FIG. 1.

FIG. 3 shows an exploded appearance perspective view schematically illustrating the connection between the grounding structure and the flat cable of FIG. 2.

FIG. 4 shows a top view schematically illustrating the connection between the grounding structure and the flat cable of FIG. 3.

FIG. 5 shows a side cross-sectional view schematically illustrating FIG. 4.

FIG. 6 shows an exploded appearance perspective view schematically illustrating the connection between the grounding structure and the flat cable according to the second embodiment of the present disclosure.

FIG. 7 shows a view schematically illustrating the appearance and the assembled connection between the grounding structure and the flat cable of FIG. 6.

FIG. 8 shows a bottom view schematically illustrating FIG. 7.

FIG. 9 shows a top view schematically illustrating the connection between the flat cable of FIG. 6 and the plug of the connector.

FIG. 10 shows a side cross-sectional view schematically illustrating the connection between the flat cable and the plug of the connector of FIG. 9.

### DETAILED DESCRIPTION

The technical contents and the detailed descriptions of the present disclosure are now described below with reference to the accompanying drawings:

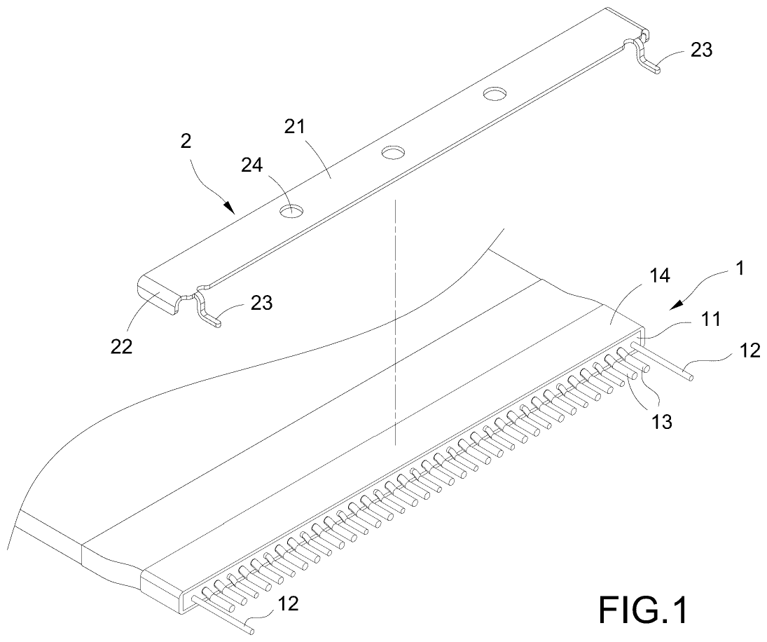

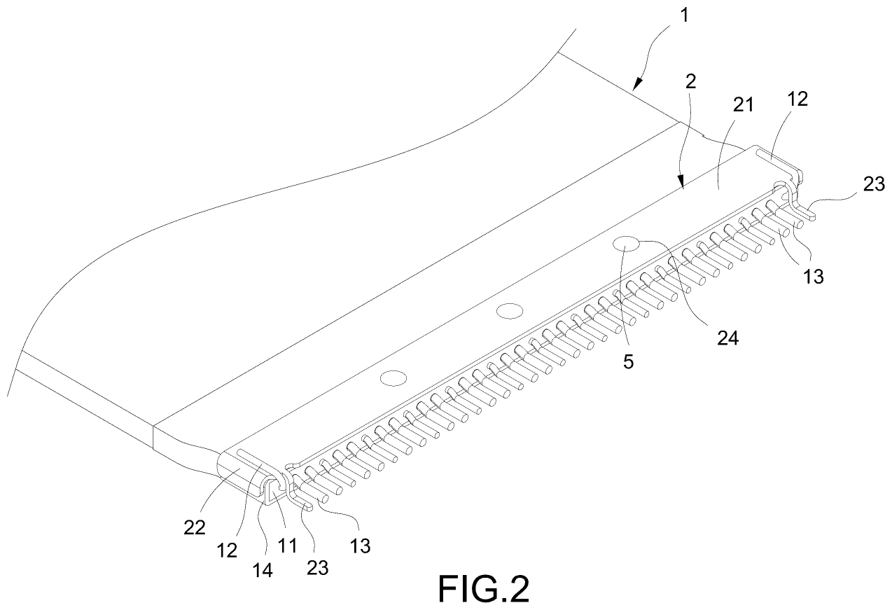

FIG. 1 shows an exploded appearance perspective view schematically illustrating the connection between the grounding structure and the flat cable according to the first embodiment of the present disclosure. FIG. 2 shows a view schematically illustrating the appearance and the assembled connection between the grounding structure and the flat cable of FIG. 1. As shown in the drawings, the high-speed connector of the present disclosure at least includes a flat cable 1 and a grounding structure 2. Moreover, the grounding structure 2 is assembled on the flat cable 1 and electrically connected to the grounding wires 12 of the flat cable 1, thereby achieving better signal performance and making the signals transmitted by the flat cable 1 more stable and less prone to attenuation or interference.

The flat cable 1 includes a plurality of grounding wires 12 and a plurality of signal wires 13 arranged in sequence, and includes a bundle clamping portion 11 on the grounding wires 12 and the signal wires 13. The grounding wires 12 and the signal wires 13 extend outwardly from one side of the bundle clamping portion 11 to be exposed. Moreover, an arrangement of the grounding wires 12 and the signal wires 13 is sequentially from right to left as follows: a first grounding wire 12, a second signal wire 13, a third signal wire 13, a fourth grounding wire 12, a fifth signal wire 13, a sixth signal wire 13, and so on, up to a last grounding wire 12.

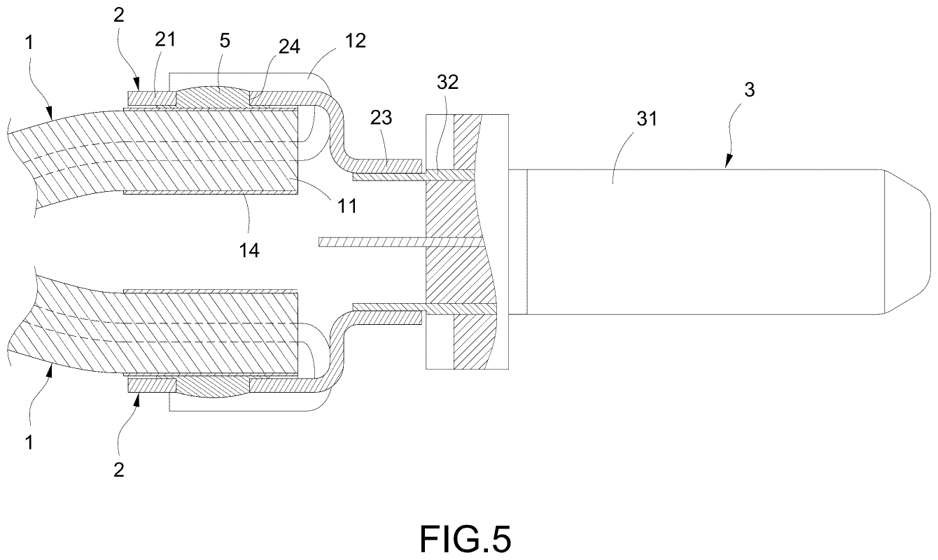

The grounding structure 2 is assembled on the bundle clamping portion 11 of the flat cable 1. The grounding structure 2 includes a body 21 which is in a form of a long strip or a plate. Two wings of the body 21 are bent to form two clamping portions 22 which are symmetrical to each other. After the grounding structure 2 is assembled on the bundle clamping portion 11, the two clamping portions 22 clamp onto two wings of the bundle clamping portion 11, thereby securely assembling the grounding structure 2 onto the bundle clamping portion 11. Moreover, two contact legs 23 which are symmetrical to each other extend from one side of the two wings of the body 21, respectively. After the grounding structure 2 is assembled on the bundle clamping portion 11, the two grounding wires 12 on two wings of the flat cable 1 are bent upward or downward to be electrically connected to the body 21. The two contact legs 23 fill gaps left after the two grounding wires 12 are electrically connected to the body 21, so that the two contact legs 23 are arranged at a same height and adjacent to the grounding wires 12 and signal wires 13, which allows the two contact legs 23, the grounding wires 12, and the signal wires 13 to be electrically connected to a plurality of pins (not shown in the drawings) of the plug (not shown in the drawings) of the connector (not shown in the drawings). Moreover, the body 21 is provided with at least one through hole 24. Before the body 21 is assembled with the bundle clamping portion 11, a metal layer 14 is coated on a surface of the bundle clamping portion 11. After the body 21 is assembled with the bundle clamping portion 11, a solder 5 (as shown in FIG. 5) is soldered onto the through hole 24, so that the body 21 is fixedly connected to the metal layer 14. In the drawings, the metal layer 14 is an aluminum foil.

When the grounding structure 2 is assembled on the bundle clamping portion 11 of the flat cable 1, the two clamping portions 22 of the body 21 of the grounding structure 2 clamp onto the two wings of the bundle clamping portion 11, thereby securely assembling the grounding structure 2 onto the bundle clamping portion 11. At this time, after the two grounding wires 12 on the two wings (right and left) of the flat cable 1 are bent upward or downward to be electrically connected to the body 21 of the grounding structure 2, the two contact legs 23 fill the gaps left after the two grounding wires 12 are electrically connected to the body 21 of the grounding structure 2, so that the two contact legs 23 are arranged at the same height and adjacent to the grounding wires 12 and the signal wires 13. Through the design of the grounding structure 2, during signal transmission, the signal transmission achieves better performance and greater stability, and the signal is less prone to attenuation or interference.

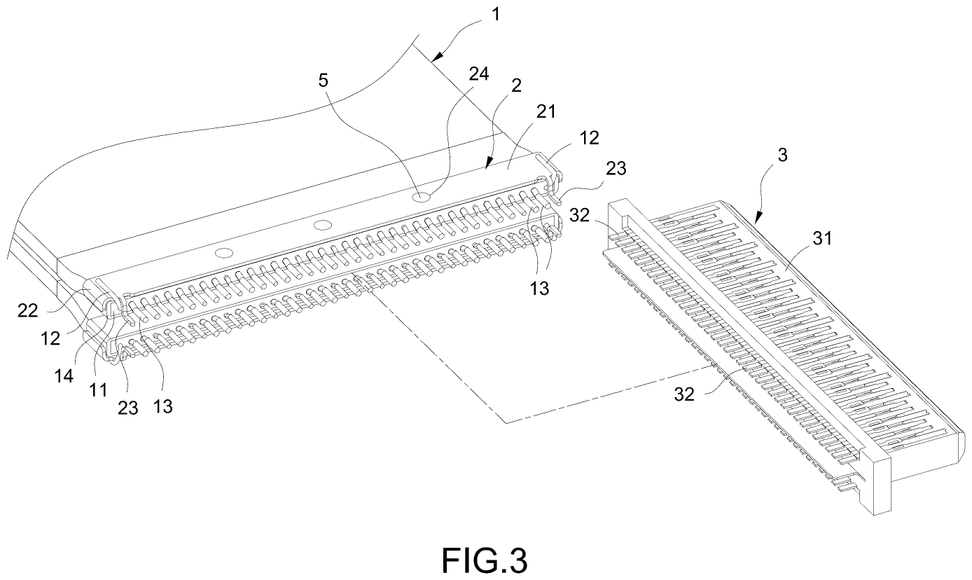

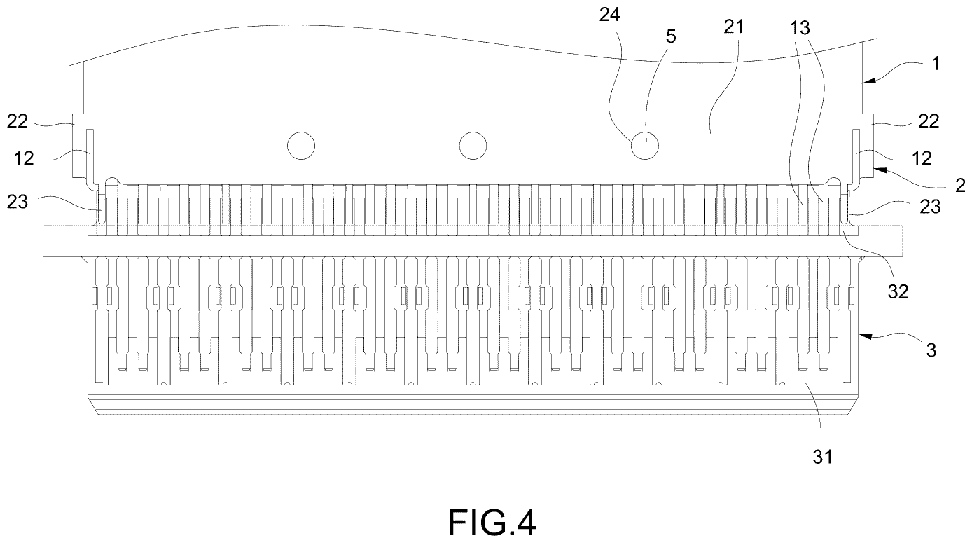

FIG. 3 shows an exploded appearance perspective view schematically illustrating the connection between the grounding structure and the flat cable of FIG. 2. FIG. 4 shows a top view schematically illustrating the connection between the grounding structure and the flat cable of FIG. 3. FIG. 5 shows a side cross-sectional view schematically illustrating FIG. 4. Please refer to FIGS. 1 and 2 at the same time. As shown in the drawings, after the grounding structure 2 of the present disclosure is assembled on the bundle clamping portion 11 of the flat cable 1, when being electrically connected to the plug 31 of the connector 3, the two contact legs 23 on one side of the two wings of the grounding structure 2 and the grounding wires 12 and the signal wires 13 of the flat cable 1 are sequentially electrically connected to a plurality of the pins 32 of the plug 31.

After the plug 31 of the connector 3 is electrically connected to the flat cable 1, during signal transmission, because a portion of the grounding wires 12 of the flat cable 1 are electrically connected to the grounding structure 2, the signal transmission achieves better performance and greater stability, making the signal less prone to attenuation or interference.

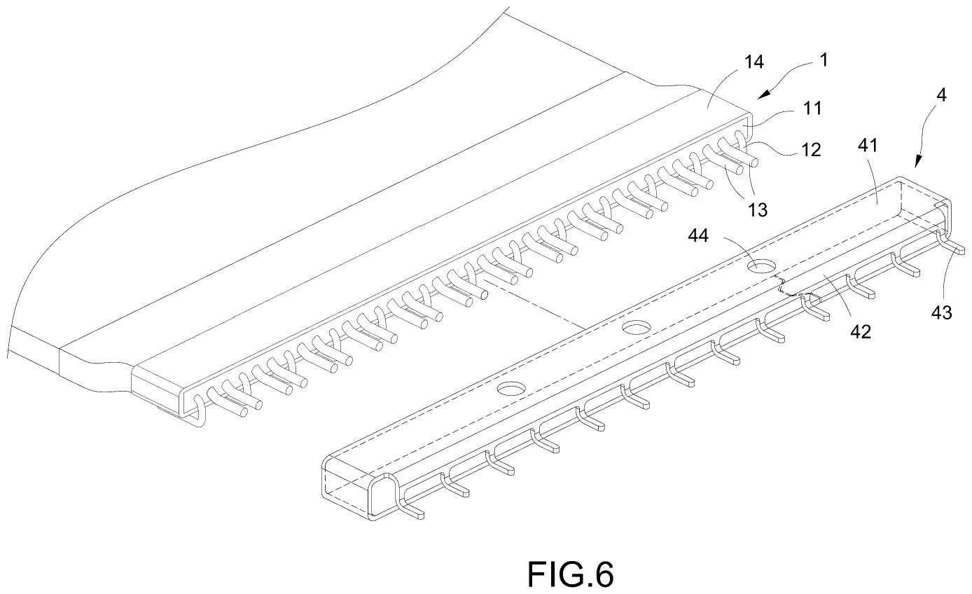

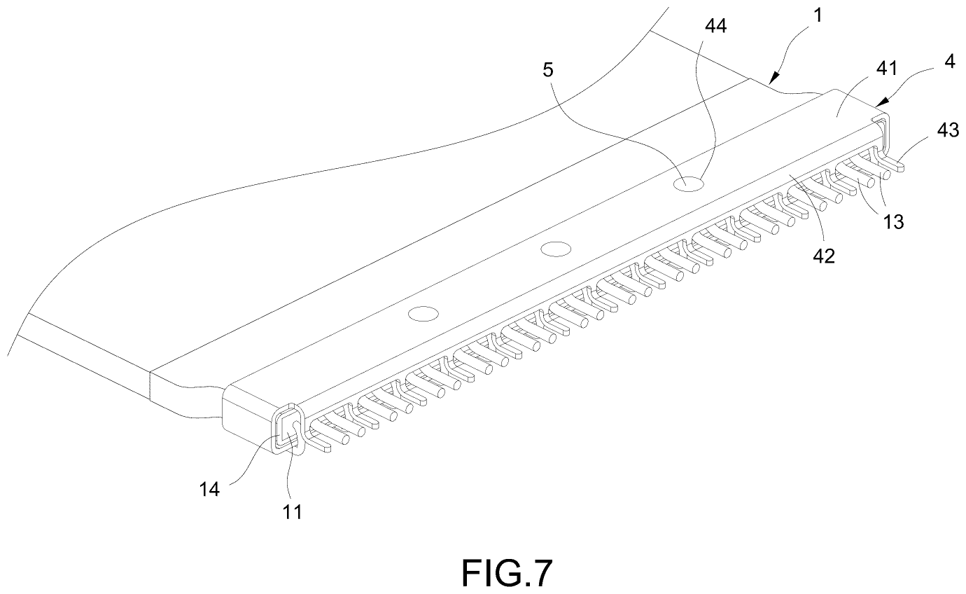

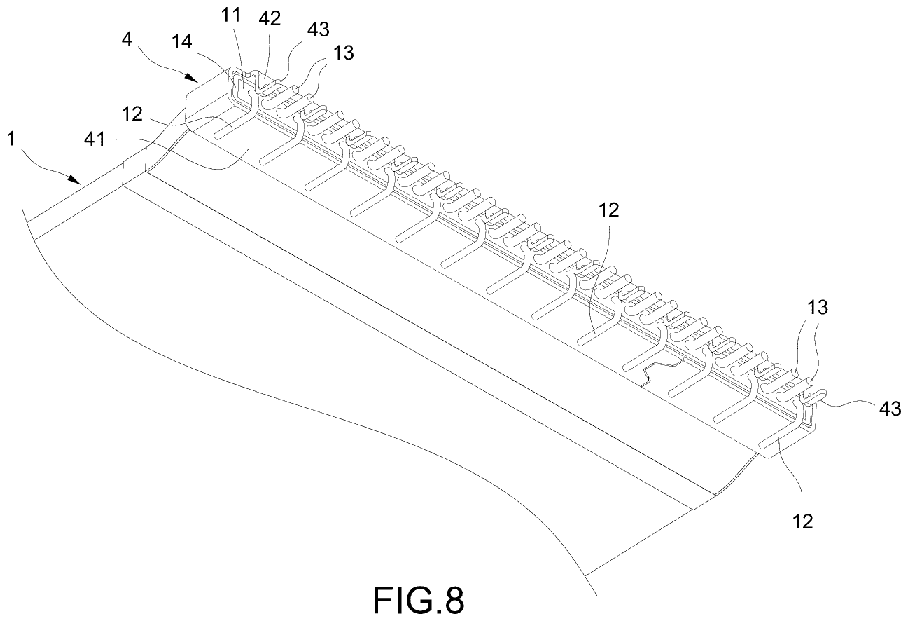

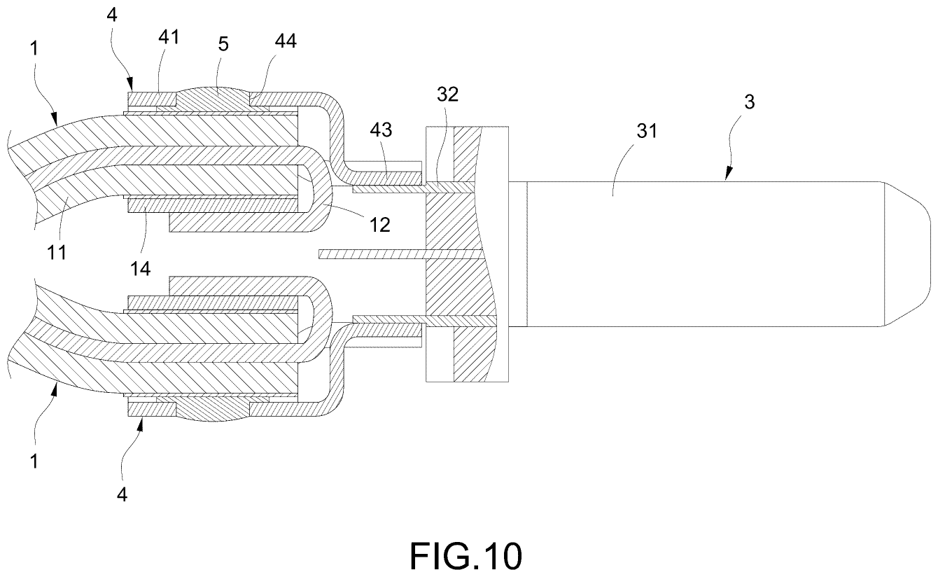

FIG. 6 shows an exploded appearance perspective view schematically illustrating the connection between the grounding structure and the flat cable according to the second embodiment of the present disclosure. FIG. 7 shows a view schematically illustrating the appearance and the assembled connection between the grounding structure and the flat cable of FIG. 6. FIG. 8 shows a bottom view schematically illustrating FIG. 7. As shown in the drawings, this embodiment is generally similar to the first embodiment, with the difference being that the grounding structure 4 includes a body 41, which is frame-shaped and mounted onto the bundle clamping portion 11 of the flat cable 1. An extension portion 42 extends from one side of the body 41. A plurality of contact legs 43 extend from one side of the extension portion 42. The contact legs 43 fill gaps left after the grounding wires 12 are electrically connected to the grounding structure 2, so that the contact legs 43 are arranged at a same height and adjacent to the signal wires 13. Moreover, the body 41 is provided with at least one through hole 44. Before the body 41 is assembled with the bundle clamping portion 11, a metal layer 14 is coated on a surface of the bundle clamping portion 11. After the body 41 is assembled with the bundle clamping portion 11, a solder 5 (as shown in FIG. 10) is soldered onto the through hole 44, so that the body 41 is fixedly connected to the metal layer 14. In the drawings, the metal layer 14 is an aluminum foil.

After the body 41 of the grounding structure 4 is assembled on the bundle clamping portion 11 of the flat cable 1, a plurality of the grounding wires 12 of the flat cable 1 are bent upward or downward to be electrically connected to the body 41, so that the contact legs 43 are positioned in the gaps left after the grounding wires 12 are electrically connected to the body 41, such that the contact legs 43 are arranged at the same height and adjacent to the signal wires 13.

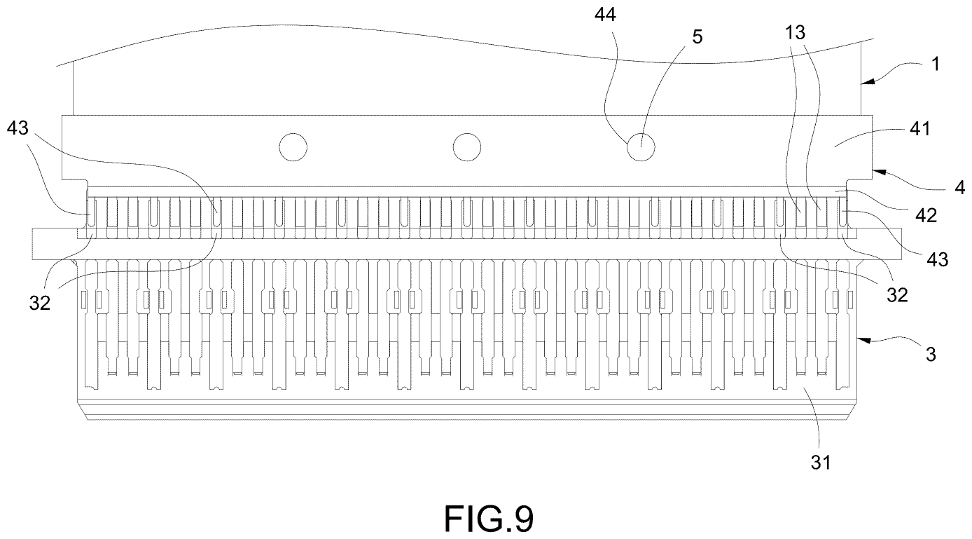

FIG. 9 shows a top view schematically illustrating the connection between the flat cable of FIG. 6 and the plug of the connector. FIG. 10 shows a side cross-sectional view schematically illustrating the connection between the flat cable and the plug of the connector of FIG. 9. Please refer to FIGS. 6-8 at the same time. As shown in the drawings, after the grounding structure 4 of the present disclosure is assembled on the bundle clamping portion 11 of the flat cable 1, when being electrically connected to the plug 31 of the connector 3, the contact legs 43 of the grounding structure 4 and the signal wires 13 of the flat cable 1 are sequentially electrically connected to the plurality of the pins 32 of the plug 31, until all the pins 32 of the plug 31 are electrically connected.

After the plug 31 of the connector 3 is electrically connected to the flat cable 1, during signal transmission, because the grounding structure 4 is electrically connected to the grounding wires 12, the signal transmission achieves better performance and greater stability, making the signal less prone to attenuation or interference.

However, the above descriptions are only preferred embodiments of the present disclosure and are not intended to limit the scope of the patent protection of the present disclosure. Therefore, any equivalent variations made based on the descriptions or drawings of the present disclosure are also considered to be within the scope of the protection of the present disclosure.

What is claimed is:

1. A high-speed connector electrically connected to a plug of a connector, the high-speed connector comprising:
a flat cable, comprising a plurality of grounding wires and a plurality of signal wires arranged in sequence, and comprising a bundle clamping portion on the grounding wires and the signal wires, wherein the grounding wires and the signal wires extend outwardly from one side of the bundle clamping portion to be exposed; and
a grounding structure, assembled on the bundle clamping portion, and comprising a body, wherein two wings of the body are bent to form two clamping portions which are symmetrical to each other, and the two clamping portions clamp onto two wings of the bundle clamping portion, and two contact legs extend from a position on one side of the two wings of the body,
wherein after the body is assembled on the bundle clamping portion, the two grounding wires on two wings of the flat cable are electrically connected to the body, so that the two contact legs are positioned in gaps left after the two grounding wires are electrically connected to the body; the two contact legs, the grounding wires, and the signal wires are electrically connected to a plurality of pins of the plug.

2. The high-speed connector according to claim 1, wherein an arrangement of the grounding wires and the signal wires of the flat cable is sequentially from right to left as follows: a first grounding wire, a second signal wire, a third signal wire, a fourth grounding wire, a fifth signal wire, a sixth signal wire, up to a last grounding wire;
wherein the two grounding wires on the two wings of the flat cable are bent upward or downward to be electrically connected to the body.

3. The high-speed connector according to claim 1, wherein the body is in a form of a long strip or a plate.

4. The high-speed connector according to claim 1, wherein after the body of the grounding structure is assembled on the bundle clamping portion of the flat cable, the two contact legs are arranged at a same height and adjacent to the signal wires.

5. The high-speed connector according to claim 1, wherein the body is provided with at least one through hole; a metal layer is coated on a surface of the bundle clamping portion; after the body is assembled on the bundle clamping portion, a solder is soldered onto the through hole, so that the body is fixedly connected to the metal layer.

6. A high-speed connector electrically connected to a plug of a connector, the high-speed connector comprising:
a flat cable, comprising a plurality of grounding wires and a plurality of signal wires arranged in sequence, and comprising a bundle clamping portion on the grounding wires and the signal wires, wherein the grounding wires and the signal wires extend outwardly from one side of the bundle clamping portion to be exposed; and
a grounding structure, assembled on the bundle clamping portion, and comprising a body, wherein an extension portion extends from one side of the body, and a plurality of contact legs extend from one side of the extension portion,
wherein after the body is assembled on the bundle clamping portion, the grounding wires of the flat cable are electrically connected to the body, and the contact legs are positioned in gaps left after the grounding wires are electrically connected to the body; the two contact legs and the signal wires are electrically connected to a plurality of pins of the plug.

7. The high-speed connector according to claim 6, wherein an arrangement of the grounding wires and the signal wires of the flat cable is sequentially from right to left as follows: a first grounding wire, a second signal wire, a third signal wire, a fourth grounding wire, a fifth signal wire, a sixth signal wire, up to a last grounding wire;
wherein the grounding wires of the flat cable are bent upward or downward to be electrically connected to the body.

8. The high-speed connector according to claim 6, wherein the body is frame-shaped.

9. The high-speed connector according to claim 6, wherein after the body of the grounding structure is assembled on the bundle clamping portion of the flat cable, the contact legs are arranged at a same height and adjacent to the signal wires.

10. The high-speed connector according to claim 6, wherein the body is provided with at least one through hole; a metal layer is coated on a surface of the bundle clamping portion; after the body is assembled on the bundle clamping portion, a solder is soldered onto the through hole, so that the body is fixedly connected to the metal layer.
